(19) United States
(12) Patent Application Publication
(10) Pub. No.: US 2001/0044274 A1
(43) Pub. Date: Nov. 22, 2001

(54) METHOD TO PERFORM DIALING IN A WIRELESS LOCAL LOOP SYSTEM, A WIRELESS LOCAL LOOP SYSTEM AND A TERMINAL

(76) Inventors: JARKKO JOKELAINEN, OULU (FI); PEKKA MOTTONEN, OULU (FI); PETRI MANNINEN, OULU (FI); PAAVO LAITINEN, OULU (FI); RISTO PUTILA, OULU (FI)

Correspondence Address: CLARENCE A GREEN, PERMAN & GREEN, 425 POST ROAD, FAIRFIELD, CT, 06430

(21) Appl. No.: 08/992,500

(22) Filed: Dec. 17, 1997

(30) Foreign Application Priority Data
Dec. 20, 1996 (FI) 965151

(51) Int. Cl. H04H 1/00

(52) U.S. Cl. 455/3.05; 455/550; 455/426

(57) ABSTRACT

The object of the invention is a method to establish an outgoing connection in a cellular system, a cellular system and a terminal. The invention is preferably applied in wireless subscriber interface systems, or in WLL systems (Wireless Local Loop). An idea of the invention is that when the terminal is set off-hook, then the tone generator (336) of the terminal generates a dial tone, which is supplied to the subscriber device (301), indicating that dialing can be started. The symbols dialed are stored as sampled symbol signals in a register (320) of the terminal (302) until a transparent audio signal communication link is established from the terminal (302) to the exchange (353). Then the symbol signals stored in the terminal's (302) register (320) are transmitted from the terminal (302) to the exchange (353). With the solution according to the invention it is possible to start dialing immediately when the subscriber device (301) is set off-hook. Further the tone signals transmitted from the exchange (353) can be heard immediately when the communication link to the exchange is established.

The object of the invention is a method to perform dialing in a Wireless Local Loop (WLL) system, a WLL system and a terminal. A preferred application of the invention is in a WLL system realized in a cellular system.

WLL systems provide an advantageous way to extend the public telephone network PSTN (Public Switched Telephone Network) to new subscribers, as the expansion can be made without cabling to each subscriber. The terminals used in WLL networks comprise a telephone set or any other subscriber device, which is suited to be connected to the public telephone network, and a transceiver unit connected to the device. The adaptation between the subscriber device and the transceiver unit is realized with a line adapter. The transceiver unit is usually connected by a radio link to a cellular service, such as the NMT system (Nordisk Mobil Telefon) or the GSM system (Global System for Mobile communications), which is further connected to the public telephone network PSTN.

Prior art is presented below by describing first in more detail a prior art WLL terminal and its connection to a communication system, and by describing then a prior art solution to perform dialing in a prior art WLL system.

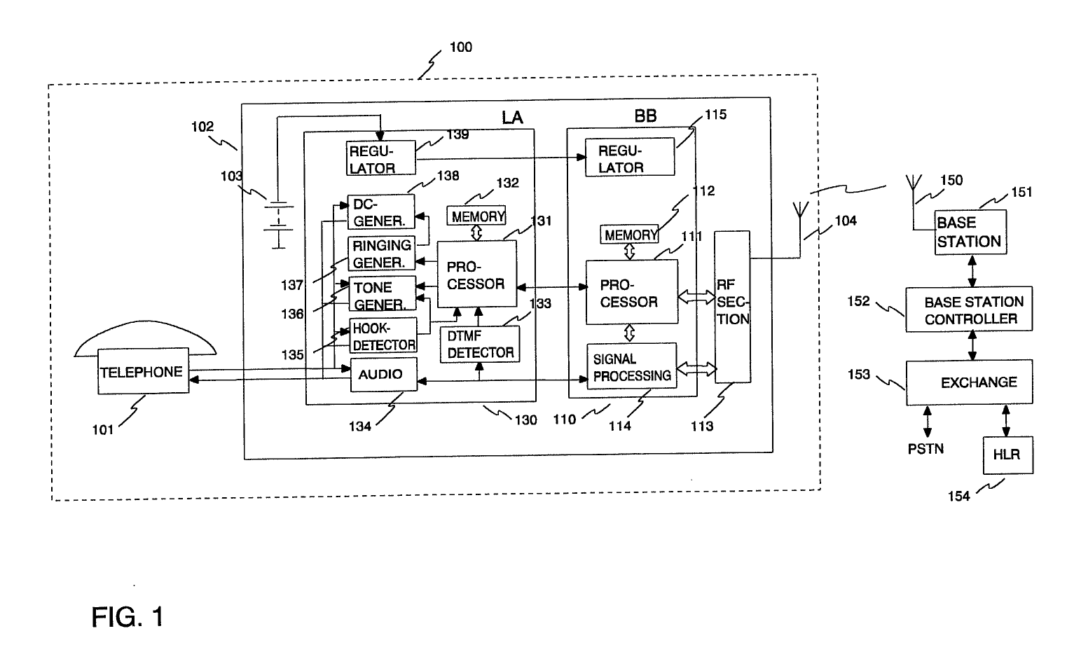

FIG. 1 shows a well known solution for the realization of a WLL terminal. There the wireless subscriber interface 100 comprises a WLL terminal 102, a subscriber device 101 and an antenna 104. The subscriber interface 100 is connected to a cellular system comprising base stations 151 for transmitting information by radio means, through the antenna 150 to the terminal equipment. The base stations are connected to base station controllers 152, which are further connected to an exchange 153. The exchange 153 is connected to the public telephone network PSTN. Connected to the exchange is also a home location register (HLR), which stores information about the system's subscribers.

An antenna 104 is connected to the terminal in order to transmit and receive radio frequency signals. A received signal is amplified and demodulated to a baseband signal in the RF section 113, and baseband signal processing is made in the signal processing block 114 of the baseband section 110. Correspondingly, a baseband signal to be transmitted is processed for transmission in the block 114 according to the specifications of the cellular system, and modulated to the RF frequency and amplified in the RF section 113 in order to be supplied to the antenna 104.

The signal processing and the RF section are controlled by a processor 111 with memory 112 for storing programs and parameters. The regulator 115 generates the supply voltages for the baseband section and the RF section.

The line adapter section 130 comprises an audio section 134 which adapts the audio signal of the baseband section 110 to the audio signal of the subscriber device 101, such as a telephone set. A DTMF detector 133 detects the dialing symbol signals transmitted on the audio line and supplies them to the processor 131 of the line adapter section. A hook detector 135 detects the state of the hook switch of the telephone set and supplies the status information to the processor 131 and the tone generator 136. The tone generator 136 generates the tone signals to the telephone set on the basis of status information about the connection sent by the cellular system. The ringing generator 137 generates a high voltage ringing signal for the ringing function of the telephone set. The ringing signal is regulated by the DC generator 138 so that it corresponds to the telephone set specifications. The processor 131 controls the blocks of the line adapter and communicates with the processor 111 of the mobile phone section 110, e.g. through a serial interface. The memory 132 connected to the processor 131 stores the processor program, parameters related to the line adapter functions and status information about the connection.

The prior art solution presented above is described in more detail in the patent publications U.S. Pat. No. 4,658,096, U.S. Pat. No. 4,737,975, U.S. Pat. No. 4,775,997 and U.S. Pat. No. 4,922,517.

In a system according to the above presented prior art a connection is established in the following way. When the subscriber device 101 connected to the terminal 102 goes off-hook, the terminal 102 generates the dialing tone for the subscriber device 101. Then the subscriber can start dialing symbols, usually digits. During symbol dialing the subscriber device 101 generates a symbol signal related to the dialed symbol, whereby the signal can be e.g. a DTMF tone signal or a dialing impulse signal. The signals generated by the subscriber device are converted in the terminal's DTMF detector 133 into digital digits, e.g. into BCD coded digits which are stored in a buffer memory 132. The time between the dialed symbols is measured, e.g. by a timer realized in the processor 131, so that the timer is reset after each dialed symbol. If the timer value exceeds a predetermined time limit, then the whole connection code is deemed to be dialed. This time limit can be e.g. 6 seconds. Then the terminal 102 begins to establish a radio connection to the base station 151 of the cellular system.

When the connection to the base station is established, information about the dialed symbols is transmitted as digit frames to the base station controller 152. The base station controller converts the received frames into tone dialing signals with an MFT converter (Multi Frequency Tone), which then transmits the signals further to the exchange 153. When the base station controller has transmitted the dialing signals to the exchange it transmits an acknowledgment to the terminal 102 and establishes communication between the terminal and the dialed subscriber interface.

A disadvantage of the prior art solution described above is that there is a long delay after dialing the connection code until the radio link to the exchange is established. This delay is the time value, e.g. 6 seconds, set in said timer, in addition to the time required to establish the radio link. If the radio connection set-up is unsuccessful, then the user gets a busy tone only after this delay.

Another problem with the above presented prior art is that the user of the subscriber device will not get any of the tone signals which the exchange generates during the connection set-up. For instance, in a situation where the user of the subscriber device has previously programmed a call transfer for his subscriber interface, the exchange usually transmits a tone signal different from the normal during the connection set-up, whereby this signal is meant to indicate to the user of the subscriber device that the call transfer is programmed. The user of the subscriber device will at no point hear the tone signal addressed to him, because the prior art WLL system does not transmit to the subscriber the tones generated by the exchange during the connection set-up.

One solution to the above stated disadvantage would be to establish first an audio signal transmission path between the subscriber device and the exchange, and to dial the connection code over this transparent communication channel. Then the voice frequency signals generated by the subscriber device, and the tone signals transmitted by the exchange would be transparently transmitted on the communication channel, whereby the user of the subscriber device would hear the tone signals transmitted by the exchange.

However, a drawback of the last mentioned solution is that when the subscriber device has gone off-hook, it will take a certain time before the communication link to the base station, and further to the exchange, has been established and before the system supplies the dial tone. Even if the length of this delay is only a few seconds, it is considerably longer than in in the public landline telephone network, and therefore the user may conceive is as irritating. Because the symbol dialing can be started only when the connection to the exchange is established, this also causes an extra delay in setting up the dialed connection.

The object of the present invention is to create a solution for setting up a communication link with which the above mentioned disadvantages can be avoided.

One inventive idea is that when the terminal goes off-hook, then the terminal generates a dial tone which is supplied to the subscriber device to indicate that symbol dialing can be started. The symbol signals generated by the subscriber device are sampled, and the sampled signals are stored in a register until the transparent audio signal communication link from the terminal to the exchange is established. Then the symbol signals stored in the terminal's register are transmitted from the terminal to the exchange.

With the solution according to the invention the symbol dialing can be started immediately when the subscriber device goes off-hook. Further, the tone signals transmitted from the exchange are audible immediately when the communication link is established to the exchange.

The method according to the invention to perform dialing in a wireless local loop system, comprising:

dialing a connection code comprising at least one symbol;

generating a symbol signal representing the dialed symbol; and

transmitting the dialing information from the terminal to the exchange in order to select the connection;

is characterized in that

said symbol belonging to the connection code is dialed before the communication link between the terminal and the exchange is established;

the symbol signal generated on the basis of the dialed symbol is sampled;

the sampled symbol signal is stored;

the stored symbol signal is read when the communication link between the terminal and the exchange is established; and

the read symbol signal is transmitted as said dialing information from the terminal to the exchange.

A wireless subscriber interface system according to the invention and comprising:

at least one terminal;

a subscriber device connected to the terminal;

at least one base station;

means to dial a connection code comprising at least one symbol;

means to generate a symbol signal on the basis of the dialed symbol;

communication means to transmit the dialing information from the terminal to the exchange; and

means to establish a communication link from the terminal on the basis of the transmitted dialing information;

is characterized in that it further comprises

sampling means for sampling said symbol signal;

a register for storing the sampled symbol signal;

means to read the symbol signal stored in the register; and

means to transmit the read symbol signal as dialing information from the terminal to the exchange.

A terminal according to the invention which can be connected to a WLL communication system and which comprises:

an interface to connect a subscriber device to the terminal;

means to receive symbol signals from the subscriber device connected to the terminal; and

communication means for transmitting the dialing information to an exchange of the communication system;

characterized in that if further comprises:

sampling means for sampling the received symbol signal;

a register for storing the sampled symbol signal;

means to read the symbol signal stored in the register; and

means to transmit the read symbol signal to the exchange.

Preferred embodiments of the invention are presented in the dependent claims.

The invention is described in more detail below with reference to the enclosed drawing, in which:

FIG. 1 shows a block diagram of a prior art WLL terminal and its connection to a cellular system;

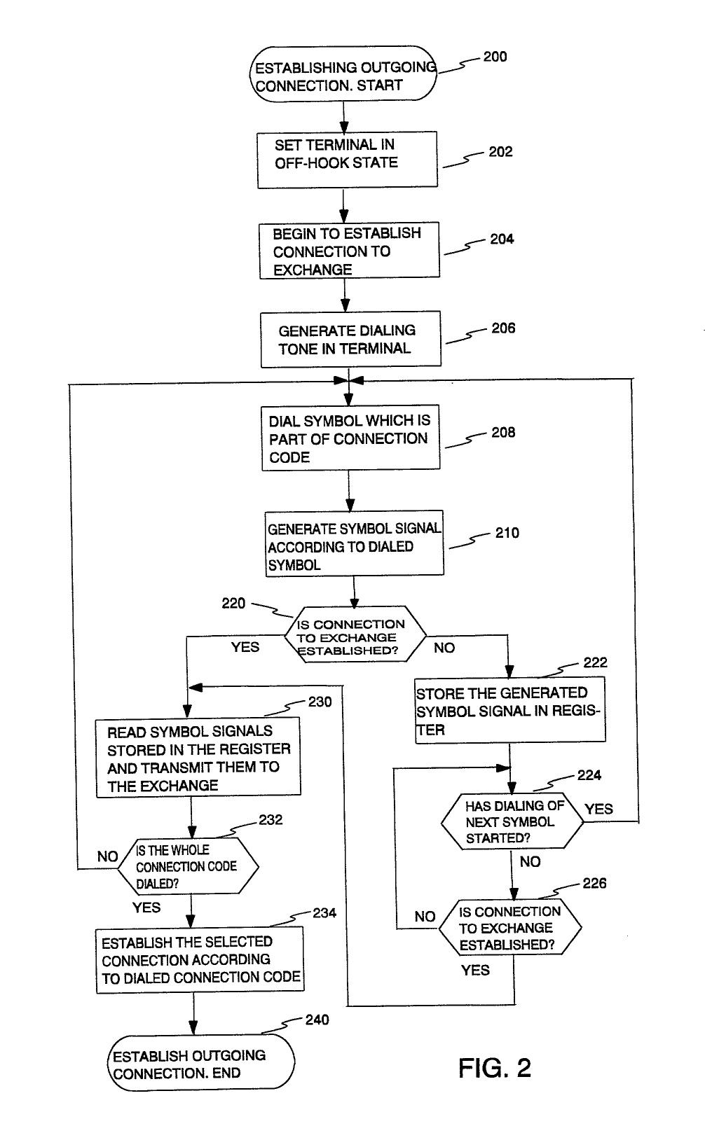

FIG. 2 shows in a flow diagram a method according to the invention for establishing an outgoing connection; and

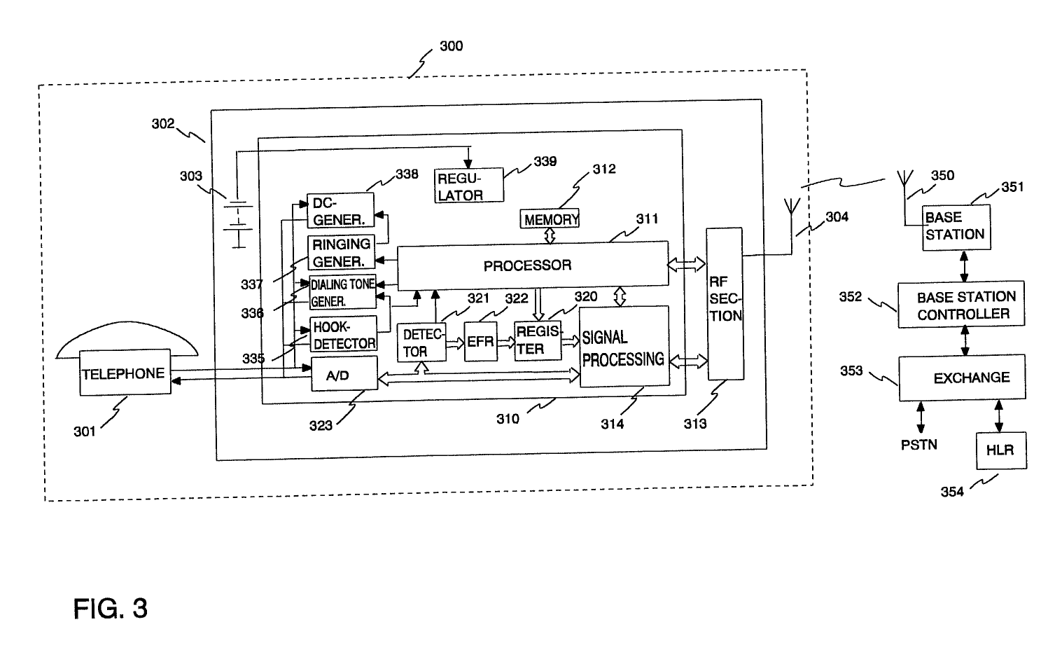

FIG. 3 shows a block diagram of a WLL terminal according to the invention and its connection to a cellular system.

FIG. 1 was already described above relating to the prior art description.

FIG. 2 shows in a flow diagram a method according to the invention for establishing an outgoing connection 200. In step 202 the terminal is first set off-hook, which means that the user has activated his subscriber device in order to initiate an outgoing connection. This is made e.g. by lifting the telephone receiver, whereby the changed state of the hook switch is transmitted to the processor of the terminal.

Then begins the establishing of the connection from the terminal to the exchange, or the making of the exchange connection, step 204. At the same time the terminal generates a dialing tone to the user, step 206. When the user hears the dialing tone, he can begin to dial the connection code comprising a symbol sequence, or more generally to dial the number. When the user has dialed the first symbol in step 208, the generation of the dialing tone is stopped (not shown in FIG. 2). Then in step 210 a tone frequency dialing signal or a symbol signal is generated according to the dialed symbol.

Next in step 220 is made a check whether a communication link to the exchange is established. If no exchange connection was established, then the generated symbol signal is stored in a register, step 222. Then a check is made whether dialing of the next symbol has begun, step 224. If dialing has begun the process continues at step 208. If the dialing of the next symbol, in step 224, has not begun, it is checked whether the exchange connection is established. If the exchange connection is not established, the process returns to step 224. Then the steps 224 and 226 are repeated until dialing of the next symbol has begun or until the exchange connection is established.

When it is determined in step 220 or in step 226 that the exchange connection is established, the process continues at step 230. In this step the symbol signals possibly stored in the register are read and transmitted from the terminal to the exchange. If a new symbol is dialed simultaneously, the corresponding symbol signal is also stored in the register and transmitted to the exchange after the earlier stored symbol signals.

The next step depends on whether all symbols of the connection code have been dialed, step 232. If some symbols are still not dialed, the process continues at step 208. If the whole connection code has been dialed, the dialed connection in the communication system is established on the basis of said connection code in step 234, whereby the method for establishing an outgoing connection is completed, step 240.

FIG. 3 shows in a block diagram a wireless subscriber interface 300 and its connection to a communication system. The terminal 302 belonging to the subscriber interface comprises a hook detector 335, which indicates to the processor 311 and to the dial tone generator 336 the state of the hook switch of the subscriber device 301 connected to the terminal. When the subscriber device 301 goes off-hook the dialing tone generator 336 generates the dial tone for the subscriber device. When the user has dialed the first symbol the symbol signal transmitted from the subscriber device 301 is detected in the detector 321, which transmits to the processor 311 the information that dialing has started. Then the processor 311 further controls the dial tone generator 336 to stop generating the dial tone.

According to the invention the terminal comprises a shift register 320 of the FIFO type (Firs In - First Out) for storing the symbol signals corresponding to the dialed symbols. The analog symbol signal generated by the subscriber device 301 is first converted into digital samples by an analog-to-digital converter 323. The audio signal converted into a digital form is supplied to the detector 321, which detects when a symbol signal appears on the audio signal line. The detector is preferably a detector operating with an algorithm according to the VAD (Voice Activity Detection) function. The detector can also comprise a DTMF detector. The object of the detector is to avoid interference signals from being stored in the register.

When a symbol signal is detected, the signal is encoded, preferably by an EFR (Enhanced Full Rate) algorithm in the encoder 322. By using an encoding according to this algorithm the symbol signals can be transparently transmitted on the communication channel. The encoded signal sample sequence is then stored in the register 320.

When a transparent communication link has been established between the terminal and the exchange the register unloading is begun by reading the samples and by transmitting them to the exchange on the established communication channel. Controlled by the processor 311 a pause of standard length is inserted in place of the removed periods. This algorithm operation continues until the terminal has transmitted all dialing information stored in the register. Then any symbol signals, not yet dialed, will be transmitted to the exchange without storing them in the register. When the symbol signals have been transmitted the terminal uses the system's conventional speech encoding algorithm in the signal processing unit 114.

Detected tone frequency dialing signals can be buffered as such in the register, or they can be shortened to a standard length. The use of tone frequency dialing periods with a standard length will reduce the register's capacity requirements.

The structure of the equipment in FIG. 3 was presented above regarding the functions which relate to the invention. In other respects the blocks in FIG. 3 operate in the same way as corresponding blocks shown in FIG. 1, taking into account that the processor 311 and the memory 312 perform the corresponding operations as the processor 111 and 131 and the memories 112 and 132 shown in FIG. 1.

Some embodiments of the method according to the invention were presented above. It is naturally possible to modify the inventive principle within the scope of the claims, for instance regarding the details of the realization and the areas of use.

1. A method to perform dialing in a wireless subscriber interface system, comprising:
dialing a connection code comprising at least one symbol (208);
generating a symbol signal representing the dialed symbol (210); and
transmitting the dialing information from the terminal to the exchange in order to select the connection;
characterized in that
said symbol belonging to the connection code is dialed (208) before the communication link between the terminal and the exchange is established (220, 226);
the symbol signal generated on the basis of the dialed symbol is sampled;
the sampled symbol signal is stored (222);
the stored symbol signal is read (230) when the communication link between the terminal and the exchange is established; and
the read symbol signal is transmitted as said dialing information from the terminal to the exchange (230).

2. A method according to claim 1, characterized in that a dial tone to the subscriber device is generated (206) before the communication link between the terminal and the exchange is established (226, 230).

3. A method according to claim 1 or 2, characterized in that a transparent signaling link is established between the terminal and the exchange.

4. A method according to any previous claim, characterized in that the symbol signal is EFR encoded for storage and transmission.

5. A wireless subscriber interface system comprising:
at least one terminal (302);
a subscriber device (301) connected to the terminal;
at least one base station (351);
means (301) to dial a connection code comprising at least one symbol;
means (301) to generate a symbol signal on the basis of the dialed symbol;
communication means (310, 313, 304, 350, 351) to transmit the dialing information from the terminal to the exchange; and
means (352, 353) to establish a communication link from the terminal on the basis of the transmitted dialing information;
characterized in that it further comprises
sampling means (323) for sampling said symbol signal;
a register (320) for storing the sampled symbol signal;
means (311, 314) to read the symbol signal stored in the register; and
means (322, 314, 313, 304, 350, 351) to transmit the read symbol signal as dialing information from the terminal to the exchange.

6. A wireless subscriber interface system according to claim 5, characterized in that it comprises means to establish a transparent connection between the terminal and the exchange.

7. A terminal which can be connected to a WLL communication system and which comprises:
an interface to connect a subscriber device (301) to the terminal;
means to receive symbol signals from the subscriber device connected to the terminal; and
communication means for transmitting the dialing information to an exchange of the communication system;
characterized in that if further comprises:
sampling means (323) for sampling the received symbol signal;
a register (320) for storing the sampled symbol signal;
means (311, 314) to read the symbol signal stored in the register; and
means (313, 314) to transmit the read symbol signal to the exchange.

8. A terminal according to claim 7, characterized in that it comprises means (336) to generate a dial tone to the subscriber device.

9. A terminal according to claim 7 or 8, characterized in that it comprises means to establish a transparent signaling connection between the terminal and the exchange.

10. A terminal according to claim 9, characterized in that it comprises an EFR encoder (322) in order to encode the sampled symbol signal for storage and transmission.
